(19) United States
(12) Patent Application Publication
(10) Pub. No.: US 2007/0153693 A1
(43) Pub. Date: Jul. 5, 2007

(54) TRANSPORT FORMAT DETECTING APPARATUS AND METHOD

(75) Inventor: Mitsunori TAKANASHI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 11/613,927

(22) Filed: Dec. 20, 2006

(30) Foreign Application Priority Data
Jan. 5, 2006 (JP) 2006-000537

(51) Int. Cl. H04L 12/26

(52) U.S. Cl. 370/232; 370/236; 370/535

(57) ABSTRACT

To provide transport format detecting apparatus and method capable of reducing a period necessary for detecting a transport format and saving current consumption. A transport format detecting apparatus according to an embodiment of the invention includes: a Viterbi decoding unit calculating likelihood information of a plurality of paths up to each state of a trellis diagram based on a received sequence to generate a decoded sequence; a differential operational unit calculating a difference between the likelihood information in each state; a decoding control unit stopping generation of decoded sequence with the Viterbi decoding unit based on the difference between the likelihood information; and a transport format output unit detecting a transport format based on a size of the generated decoded sequence.

### BACKGROUND OF THE INVENTION

1. Field of the Invention

The present invention relates to transport format detecting apparatus and method, and more particularly to transport format detecting apparatus and method for detecting a transport format based on a decoded size of a received data sequence.

2. Description of Related Art

The 3GPP (3rd Generation Partnership Project) has promoted standardization of 3rd generation mobile communication system. As an example of standard communication systems conforming to the 3GPP, there has been known a W-CDMA (Wideband Code Division Multiple Access) system.

A data format transmitted/received in the W-CDMA mobile communication system is described in, for example, “3GPP (3rd Generation Partnership Project) TS (Technical Specification) 25.212 V6.5.0” at the Internet URL<http://www.3gpp.org/ftp/Specs/archive/25_series/25.212/25212-650.zip> (a search was made online for this specification on June, 2005). In the W-CDMA system, plural physical channels are multiplexed on a radio transmission path, and in addition, transport channels (hereinafter referred to as “TrCHs”) are multiplexed on each physical channel. Since the plural TrCHs are provided, various types of information such as sounds or images can be concurrently transmitted/received through individual channels and with a transmission quality suitable for each service.

In the W-CDMA system, composite combination transport channels (Composite Combination TrCHs; hereinafter referred to as “CCTrCHs”) composed of plural TrCHs are transmitted on the physical channel. Each TrCH includes an arbitrary number of data of a predetermined data length. The data length is defined as a transport format (hereinafter referred to as “TF”). Further, a CCTrCH format is defined by a transport format combination (hereinafter referred to as “TFC”), and the TFC defines TrCHs and combinations of TFs in each TrCH.

Any combination can be adopted for each CCTrCH transported on the physical channel in accordance with an arbitrary TFC. A TFC can be changed during data communications. For example, a TF is changed in accordance with a transported data amount (data size) to thereby improve communication efficiency. Since the TFC changes in some cases, a receiving side needs to specify a TFC used for current communications. Unless data is decoded with a size (TF) appropriate for decoding each TrCH, received data cannot be decoded correctly.

There are described several methods of determining a TFC in “3GPP (3rd Generation Partnership Project) TS (Technical Specification) 25.212 V6.5.0” at the Internet URL<http://www.3gpp.org/ftp/Specs/archive/25_series/25.212/25212-650.zip> (a search was made online for this specification on June, 2005). For example, there are methods using a transport format combination indicator (hereinafter referred to as “TFCI”). The TFCI is information for identifying a TFC of CCTrCHs. According to the method using the TFCI, the CCTrCH and the TFCI are transported on the physical channel. The receiving side decodes the TFCI prior to the CCTrCH to identify the TFC corresponding to the THCI. Then, each TrCH of the CCTrCH is decoded based on a TF of each TrCH defined by the TFC to obtain correctly decoded data.

Further, as another method of determining a TFC, there is a method of determining a TFC based on a decoded size of an explicit detectable Trch without using the TFCI if no TFCI is transported on a physical channel. The explicit detectable TrCH is one of TrCHs in the CCTrCH. The receiving side first decodes the explicit detectable TrCH in the CCTrCH to detect a TF of the explicit detectable TrCH based on a size of the decoded data at the time of decoding the CCTrCH. Then, a TFC is identified in accordance with the detected TF, and each TrCH of the CCTrCH is decoded based on the TF of each TrCH defined by the TFC. In this way, the method of detecting a TF based on the size of the decoded data of the explicit detectable TrCH is called “Blind Transport Format Detection” (hereinafter referred to as “BTFD”).

FIG. 7 shows a format of the explicit detectable TrCH used in the BTFD. As shown in FIG. 7, the explicit detectable TrCH is composed of a data area, a CRC (Cyclic Redundancy Check) area, and an empty area. The data area stores communication data such as sounds. The CRC area stores a CRC value for detecting an error of the data area. The empty area stores only empty data not including communication data, that is, including only noises in a communication path. The entire size of the explicit detectable TrCH is the maximum length of a standardized TrCH, and the TF corresponds to the total size of the data area and the CRC area. As indicated by an area from TF#0 to #3 of FIG. 7, a candidate TF (candidate size) available in the explicit detectable TrCH is previously defined, and one of the plural candidate TFs is a true TF. In FIG. 7, TF#2 is the true TF.

The explicit detectable TrCH is encoded by a convolutional code on the transmitting side.

The convolutional code is described next. FIG. 8 shows a configuration example of a convolutional coder. The convolutional coder convolutional-codes input data (information sequence) U to output encoded data (encoded sequence) X. The encoded data X is composed of repetitive data sequence of 2-bit data, coding bits X0, X1.

In the convolutional coder, the input data U is sequentially delayed by one bit by series-connected registers (delay elements) D0 and D1, and an exclusive OR operation result of the input data U and delay bits thereof is referred to as “encoded data X”. That is, the coding bit X0 is the exclusive OR of the input data U, and 1-bit delay and 2-bit delay (X0=U+D0+D1), and the coding bit X1 is the exclusive OR of the input data U and 2-bit delay (X1=U+D1). In general, the constraint length corresponds to “the number of registers+1”, and the constraint length k of the convolutional coder is 3. The convolutional coder obtains 2-bit encoded data for 1-bit input data, so a coding rate r is ½.

The constraint length is a bit rate (bit length) of past input data necessary for obtaining encoded data. If the constraint length increases, an error correction ability is improved, but the configuration of a decoder side is complicated. The coding rate is a bit ratio between input data and output encoded data. In the case where the coding rate is small, that is, a bit rate of output data relative to input data is high, a transport speed is lowered, but the error correcting ability increases.

FIG. 9 is a trellis diagram showing a state transition of the convolutional coder of FIG. 8. In FIG. 9, the circle indicates a state at each time point (T0, T1), and the line connecting between the states is a branch. Further, a path connects between the plural branches.

States S00 (S0), S01 (S1), S10 (S2), and S11 (S3) represent registration states of the registers D0 and D1. The first bit subsequent to S represents a state of the register D0, and the second bit subsequent to S represents a state of the register D1. For example, when a value of the register D0 is 0, and a value of the register D1 is 1, the state is S01. The 2-bit number assigned to each branch is the coding bits X0, X1 output from the coder upon the state transition. For example, if a value of 1 is input in the state S10, “X0, X1”=“0, 1” is output, and the state is shifted to the state S11.

FIG. 10 shows an example of the encoded data obtained by encoding input data with the convolutional coder of FIG. 8. FIG. 11 is a trellis diagram showing state transition at the time of generating encoded data of FIG. 10. At time T0, that is, at the start of coding, the state S00 is set. If the input data U=“10011” is input, the state is transited in the order from state S00 at time T0-state S10 at time T1-state S01 at time T2-state S00 at time T3-state S10 at time T4-state S11 at time T5. As a result, the coding bit of each branch is output, and the encoded data X=“1110111101”.

In this way, the explicit detectable TrCH is coded by convolutional coding, and the receiving side decodes the explicit detectable TrCH through Viterbi decoding. The Viterbi decoding is a maximum likelihood decoding method for decoding input data into a code of the most likelihood (closest code) The Viterbi decoding decodes input data based in the trellis diagram similar to the convolutional coder, and the likelihood of paths up to each state in the trellis diagram is calculated to decode data of a path of the maximum likelihood as a survival path.

In the explicit detectable TrCH, an empty area stores no communication data and stores only noises. Hence, if the explicit detectable TrCH is Viterbi-decoded from the first bit, the likelihood becomes high at a position of the true TF where the empty area appears, and the CRC decision result is OK. That is, the explicit detectable TrCH is Viterbi-decoded from the first bit, and the TF can be detected at a position where the likelihood is increased, and the CRC decision result is OK.

FIG. 12 is a flowchart of a method of detecting a conventional TF as described in “3GPP (3rd Generation Partnership Project) TS (Technical Specification) 25.212 V6.5.0” at the Internet URL<http://www.3gpp.org/ftp/Specs/archive/25_series/25.212/25212-650.zip> (a search was made online for this specification on June, 2005). This method decodes the explicit detectable TrCH to decode the TF.

First, the minimum candidate TF is obtained for defining a decoding range (S901). Next, ACS (Add-Compare-Select) calculation is executed from the first bit to the next bit of the explicit detectable TrCH (S902). According to the ACS calculation, the likelihood of the path of each state in the trellis diagram is calculated and compared, and a survival path is selected. Then, the ACS calculation is repeatedly executed for up to a position of a candidate TF (S903).

Next, it is determine whether or not the likelihood ratio S is a threshold value or lower (S904). The likelihood ratio S is derived from “S=−10 log (current likelihood of the state S0−current minimum likelihood)/(current maximum likelihood current minimum likelihood))”. The likelihood ratio S becomes smaller as an error rate is small (likelihood is high).

If the likelihood ratio S is equal to or smaller than a threshold value, trace back processing is carried out from a candidate TF position and then decoding is executed (S905). Next, CRC calculation is executed on decoding sequence (S906), followed by CRC decision (S907) If the CRC decision result is OK, it is determined whether or not a current likelihood ratio S is minimum (S908) If the likelihood ratio S is minimum, the current likelihood ratio S and the current TF are held (S909).

If the likelihood ratio S is larger than a threshold value in S904, the CRC decision result is NG in S907, the likelihood ratio S is not minimum in S90, or the likelihood ratio S and the TF are held in S909, it is subsequently determined whether or not the position of the candidate TF reaches the maximum length of the TrCH (S910). If the current position reaches the maximum length, the next candidate TF is obtained, and a processing subsequent to S902 is repeated (S911). Further, if the current position reaches the maximum length, the TF at the minimum likelihood ratio S is output as the true TF (S912).

Incidentally, in the technique described in HIROSUKE YAIMAMOTO and KOHJI ITOH, “Viterbi Decoding Algorithm for Convolutional Codes with Repeat Request”, IEEE TRANSACTIONS ON INFORMATION THEORY, VOL. IT-26, NO. 5, September, 1980, PP. 540-547, a likelihood difference between paths in each state of the trellis diagram upon Viterbi decoding is minimized to improve the error correcting ability.

However, in the conventional TF detecting method of FIG. 12, decoding is executed up to the maximum length of the explicit detectable TrCH and then stopped to output the true TF. That is, if a data area size is small (TF is small), for example, if a communication data amount is small, all the empty area is decoded in vain. This causes a problem in that it takes much time to detect a TF, and a circuit size or calculation amount of a TF detecting device for detecting the TF increases, resulting in an increase in current consumption.

Size reduction, a long battery life, and a lower cost are required of especially a mobile communication terminal or the like, and the problem about an increase in current consumption is serious.

### SUMMARY OF THE INVENTION

A transport format detecting apparatus according to an aspect of the invention includes: a decoding unit calculating likelihood information of a plurality of paths up to each state of a trellis diagram based on a received sequence to generate a decoded sequence; a differential operational unit calculating a difference between the likelihood information in each state; a decoding control unit stopping generation of decoded sequence with the decoding unit based on the difference between the likelihood information; and a detecting unit detecting a transport format based on a size of the generated decoded sequence. According to the transport format detecting apparatus, it is possible to complete the decoding process with a size smaller than the maximum length based on the difference between likelihood information, whereby a period necessary for detecting a transport format and current consumption can be reduced.

A transport format detecting method according to another aspect of the invention includes: calculating likelihood information of a plurality of paths up to each state of a trellis diagram based on a received sequence to generate a decoded sequence; calculating a difference between the likelihood information in each state; stopping generation of decoded sequence with the decoding unit based on the difference between the likelihood information; and detecting a transport format based on a size of the generated decoded sequence. According to the transport format detecting method, it is possible to complete the decoding process with a size smaller than the maximum length based on the difference between likelihood information, whereby a period necessary for detecting a transport format and current consumption can be reduced.

According to the present invention, it is possible to provide transport format detecting apparatus and method capable of shortening a period necessary for detecting a transport format and saving current consumption.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing the configuration of a transport format detecting apparatus according to an embodiment of the present invention;

FIG. 2 is a flowchart of a transport format detecting method according to an embodiment of the present invention;

FIG. 3 is a trellis diagram illustrating a processing of the transport format detecting method according to an embodiment of the present invention;

FIG. 4 is a trellis diagram illustrating a processing of the transport format detecting method according to an embodiment of the present invention;

FIG. 5 is a trellis diagram illustrating a processing of the transport format detecting method according to an embodiment of the present invention;

FIG. 6 shows a simulation result of the transport format detecting method according to an embodiment of the present invention;

FIG. 7 shows a data format of an explicit detectable TrCH;

FIG. 8 is a diagram showing the configuration of a convolutional coder;

FIG. 9 is a trellis diagram showing state transition of the convolutional coder;

FIG. 10 shows an example of the coding bit of data encoded by the convolutional coder;

FIG. 11 is a trellis diagram showing an example of how the convolutional coder executes coding; and

FIG. 12 is a flowchart of a conventional transport format detecting method.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

First, a transport format (TF) detecting apparatus according to a first embodiment of the present invention is described. A feature of the TF detecting apparatus of this embodiment is that if Viterbi decoding is executed up to an empty area, decoding is stopped to output the true TF.

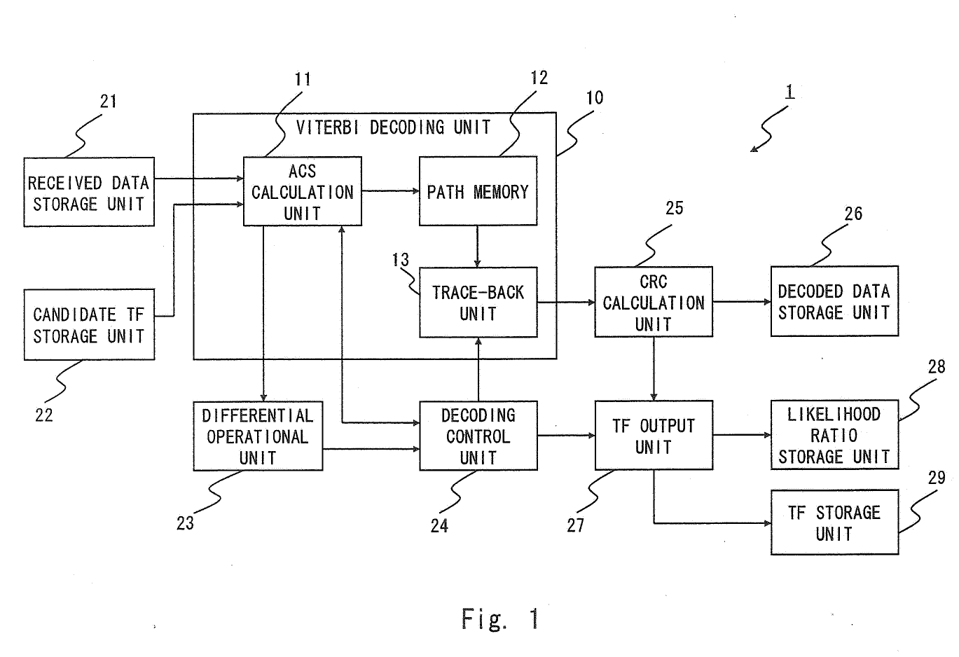

Referring now to FIG. 1, the configuration of the TF detecting apparatus of this embodiment is described. A TF detecting apparatus 1 is used in a W-CDMA mobile communication system conforming to the 3GPP, and provided in a receiving unit on a mobile terminal side or base station side that transmits/receives data through radio communication path. The TF detecting apparatus 1 decodes received data and detects a TF based on a size of the received data. That is, the TF detecting apparatus 1 is a BTFD TF detecting apparatus. The TF detecting apparatus 1 detects a TF based on received data, not a TFCI if a physical channel does not include the TFCI.

As shown in FIG. 1, the TF detecting apparatus 1 includes a Viterbi decoding unit 10, a received data storage unit 21, a candidate TF storage unit 22, a differential operational unit 23, a decoding control unit 24, a CRC calculation unit 25, a decoded data storage unit 26, a TF output unit 27, a likelihood ratio storage unit 28, and a TF storage unit 29.

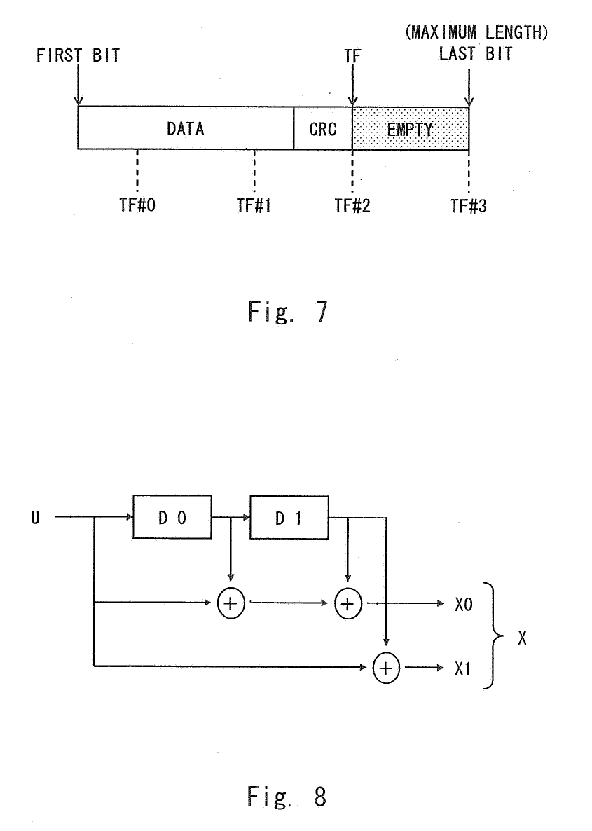

The received data storage unit 21 is a memory storing received data (received sequence) as input data. The input received data is explicit detectable TrCH in a CCTrCH transmitted on a predetermined physical channel, and a format of the data is shown in FIG. 7. Further, the received data includes noises of a radio communication path.

The candidate TF storage unit 22 is a memory storing plural candidate TFs (candidate sizes) available in the explicit detectable TrCH. The candidate TF storage unit 22 prestores plural (for example, 16) candidate TFs. For example, the plural candidate TFs are arrange in ascending order, and are read out in the order from the top. TF detecting apparatus 1 selects and outputs the true TF (data size) from the plural candidate TFs.

The Viterbi decoding unit 10 is a decoder decoding received data based on Viterbi algorithm. The Viterbi decoding unit 10 reads out data of the explicit detectable TrCH stored in the received data storage unit 21 and decodes the data from the first bit of the data to a position where the TF is detected.

The explicit detectable TrCH as the received data is coded through convolutional coding. For example, a constraint length of the convolutional coding is 9. If the convolutional-coded data is decoded under the condition that the constraint length is 9, a trellis diagram includes 256 states. The Viterbi decoding unit 10 calculates likelihood information and executes decoding for each of the 256 states.

As shown in FIG. 1, the Viterbi decoding unit 10 includes an ACS calculating unit 11, a path memory 12, and a trace back unit 13.

The ACS calculating unit 11 obtains the received data in the received data storage unit 21 and the candidate TF in the candidate TF storage unit 22 to sequentially execute ACS calculation on the received data from the first bit to the candidate TF. The path memory 12 is a memory storing likelihood information and survival path information. The path memory 12 stores information about branchmetric of branches connecting between states or pathmetric of paths up to each state, and information about which one of the plural paths is a survival path, by means of the ACS calculating unit 11. The trace back unit 13 executes trace-back processing on the survival path to generate and output decoded data with reference to the path memory 12.

The differential operational unit 23 calculates a difference (likelihood difference) between likelihood information in each state, which are generated by the ACS calculating unit 11 of the Viterbi decoding unit 10. The differential operational unit 23 compares the calculated difference with a predetermined threshold value to determine whether difference determination succeeds or ends in failure.

The decoding control unit 24 stops generation of decoded data with the Viterbi decoding unit 10 based on the result of the difference determination with the differential operational unit 23 to thereby complete the decoding process. That is, the decoding control unit 24 stops processings of the ACS calculating unit 11 of the Viterbi decoding unit 10 and the trace back unit 13 based on the result of difference determination in all states at the current time point. Further, in the decoding control unit 24 (or the ACS calculating unit 11), likelihood ratio S is derived from the likelihood information at the current time point, and the decoded data is generated with the trace back unit 13 based on the likelihood ratio S.

The CRC calculation unit (cyclic redundancy check calculation unit) 25 executes CRC (cyclic redundancy check) on the decoded data generated by the trace back unit 13, followed by CRC decision.

The decoded data storage unit 26 is a memory for storing decoded data. The decoded data storage unit 26 stores decoded data while the CRC calculation unit 25 carries out the CRC decision. The stored decoded data is then processed as communication data as sounds in an upper layer.

The likelihood ratio storage unit 28 is a memory storing a likelihood ratio S determined by the decoding control unit 24 (or the ACS calculating unit 11), and stores the minimum likelihood ratio S based on the CRC decision result. The TF storage unit 29 is a memory storing a TF corresponding to the likelihood ratio S of the likelihood ratio storage unit 28, and finally stores the true TF.

The TF output unit 27 stores a current likelihood ratio S in the likelihood ratio storage unit 28 and stores a current TF in the TF storage unit 29 based on the CRC decision result by means of the CRC calculation unit 25. If decoding is completed up to the maximum length or decoding is completed for all states based on the difference determination result, the TF output unit 27 outputs a TF stored in the TF storage unit 29 as the true TF. Incidentally, a current TFC of a CCTrCH is identified based on this detected TF, and another decoder decodes remaining TrCHs based on the definition of the identified TFC.

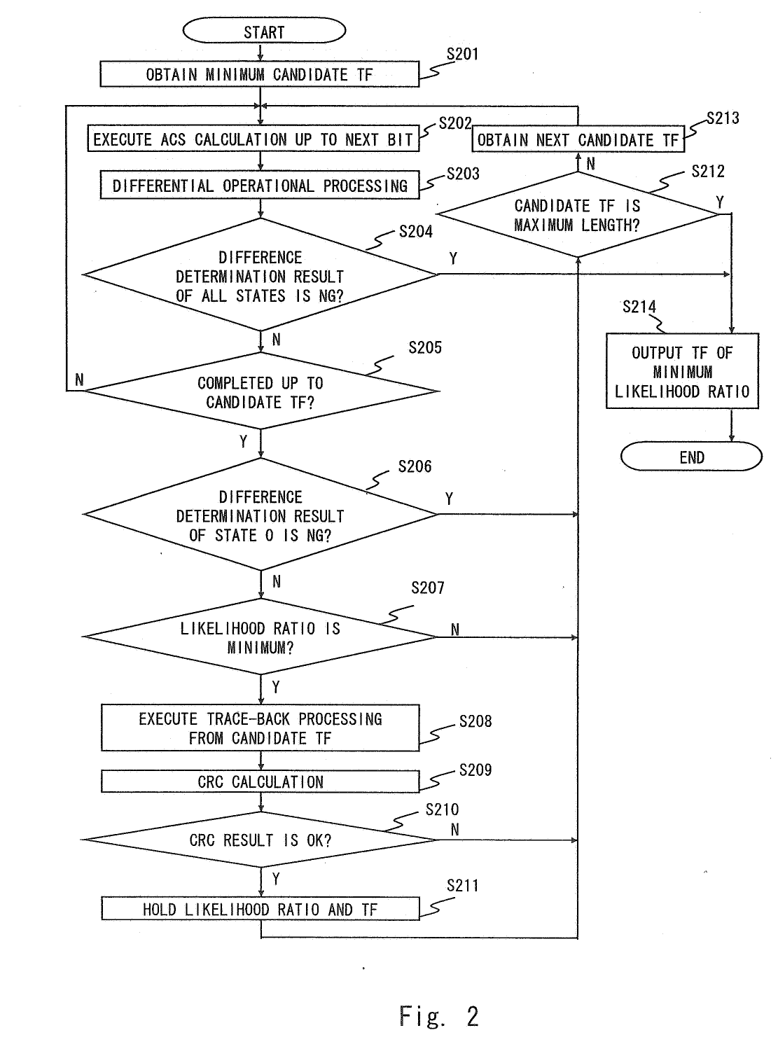

Referring next to a flowchart of FIG. 2, a TF detecting method of this embodiment is described hereinbelow. The TF detecting method decodes received data to detect a TF by use of the TF detecting apparatus 1.

First, the minimum candidate TF is obtained for defining a decoding range (S201). That is, if the received data storage unit 21 stores the received data as the explicit detectable TrCH, the ACS calculating unit 11 of the Viterbi decoding unit 10 retrieves the minimum candidate TF from the candidate TF storage unit 22.

Next, ACS calculation is carried out on the received data from the first bit to the next bit thereof (S202). That is, the ACS calculating unit 11 reads out the received data in the received data storage unit 21 sequentially from the head position, calculates likelihood information of paths in each state in the trellis diagram, compares the likelihood information, and selects a survival path.

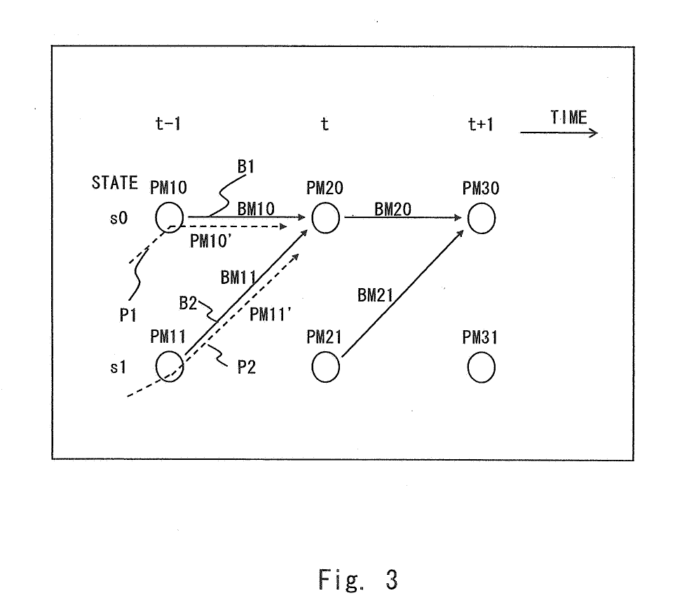

At this time, for example, as shown in FIG. 3, there are two paths reaching each state. The pathmetrics of the two paths are calculated and compared with each other. A current pathmetric is calculated by adding branchmetrics of branches from the previous point to the current point, to a pathmetric of a previous survival path. For example, as for the branchmetrics, hamming distance (hard decision) or a distance on a signal space (soft decision) is used. Then, a path of higher likelihood out of the two paths is selected as a survival path. The ACS calculating unit 11 stores information about the calculated pathmetric and the survival path in the path memory 12. The ACS calculating unit 11 calculates pathmetrics and selects a survival path for all states (for example, 256 states) at a current point.

In the illustrated example of FIG. 3, two paths P1 and P2 reach state s0 at time t from time t−1. Incidentally, out of the two paths or branches up to each state, the upper one of FIG. 3 is referred to as an upper path or upper branch, and the lower one of FIG. 3 is referred to as a lower path or lower branch (the same applies to the other drawings).

A pathmetric up to state s0 at time t−1 is referred to as PM10, a branchmetric of a branch B1 connecting between state s0 at time t−1 and state s0 at time t is referred to as B10, a pathmetric up to state s1 at time t−1 is referred to as PM11, and a branchmetric of a branch B2 connecting between state s1 at time t−1 and state s0 at time t is referred to as B11. In this condition, the pathmetric PM10′ of the upper path P1 equals “PM10+BM10”, and the pathmetric PM11′ of the lower path P2 equals “PM11+BM11”. Then, two pathmetrics PM10′ and PM11′ are compared, and one of a larger pathmetric is selected as a survival path. The pathmetric of the selected path is a pathmetric PM20 of state s0 at time t.

After the processing of S202 of FIG. 2, a difference calculation processing of calculating a difference between the likelihood information calculated by the ACS calculating unit 11 is carried out (S203) That is, the differential operational unit 23 calculates a difference between pathmetrics of paths in each state of the trellis diagram. In the ACS calculating unit 11, current pathmetrics of the two paths up to each state are calculated for selecting a survival path, and the differential operational unit 23 calculates a difference between the two pathmetrics. The differential operational unit 23 calculates a difference for all of current states.

For example, in state s0 at time t of FIG. 3, a difference between the pathmetrics PM10′ and PM11′ of the two paths P1 and P2 up to the state s0 is calculated. That is, a difference between the likelihood information is derived from “PM10−PM11′=(PM10 +BM10)−(PM11+BM11)”.

As described in HIROSUKE YAIMAMOTO and KOHJI ITOH, “Viterbi Decoding Algorithm for Convolutional Codes with Repeat Request”, IEEE TRANSACTIONS ON INFORMATION THEORY, VOL. IT-26, NO. 5, September, 1980, PP. 540-547, if the difference between the likelihood information is large, the likelihood that the survival path is correct (close) is strong. If the difference between the likelihood information of the two paths is small, the likelihood that the survival path is wrong is strong. To that end, in this embodiment, the differential operational unit 23 compares the calculated difference between the likelihood information with a threshold value. If the difference between the likelihood information is equal to or larger than the threshold value, the likelihood that the survival path is correct is strong, so the difference determination succeeds. If the difference between the likelihood information is the threshold value or smaller, the likelihood that the survival path is wrong is strong, so the difference determination ends in failure.

After the processing of S203 of FIG. 2, it is determined whether or not the difference determination ends in failure for all of current states (S204). That is, the decoding control unit 24 determines whether the result of the difference determination with the differential operational unit 23 is positive or negative for all states of the trellis diagram with reference to all the states. If the difference determination result for all states is negative in S204, the process advances to S214 to complete decoding. That is, in this embodiment, if the difference determination for all states ends in failure, and the likelihood that decoding for all states fails is strong, it is determined that the decoding process is completed up to an empty area, and the decoding process is stopped. Incidentally, information to the effect that current difference determination ends in failure may be passed to the next point. For example, in the example of FIG. 3, PM10′−PM11′ difference determination ends in failure at time t. Even if a value of (PM20+BM20)−(PM21+BM21) is larger than the threshold value at time t+1 (at this time, the likelihood of PM20+BM20 is higher than that of PM21+BM21), the result of determining a difference “(PM20+BM20)−(PM21+BM21)” is negative. That is, if the path of PM20−PM30 is selected at time t+1 of FIG. 3, the PM10′−PM11′ difference determination result is reflected on the pathmetric PM30. If the path of PM21−PM30 is selected, the difference determination result of up to the pathmetric PM21 is reflected on the pathmetric PM30.

If there is a state for which the difference determination succeeds in S204, it is determined whether or not the ACS calculation and the difference calculation are completed up to the candidate TF (8205). That is, the ACS calculating unit 11 compares a current decoding position with the candidate TF. If the current position does not reach the candidate TF, the process returns to S202, and the ACS calculation and the difference calculation are repeated.

If the current decoding position reaches the candidate TF in S205, it is determine whether or not the difference determination in current state S0 ends in failure (S206). The 3GPP defines the initial state and the final state as S0. Hence, in this case, the determination is carried out in state S0. That is, the decoding control unit 24 references the difference determination result in state S0 of the candidate TF out of the difference determination results of each state from the differential operational unit 23 to determined whether or not the determination ends in failure. If the difference determination result of state S0 is negative in S206, the process advances to S212, and the processing is continued to the next candidate TF.

If the difference determination result of state S0 is positive in S206, it is determine whether or not the likelihood ratio S is minimum. Similar to the conventional technique, the decoding control unit 24 executes control based on “likelihood ratio S=−10 log (likelihood of current state S0—current minimum likelihood)/(current maximum likelihood—current minimum likelihood)). That is, the decoding control unit 24 calculates the current likelihood ratio S, compares the likelihood ratio S stored in the likelihood ratio storage unit 28 with the current likelihood ratio S, and determines whether or not the current likelihood ratio S is smaller. If the likelihood ratio S is not minimum in S207, the process advances to S212, and the processing is executed up to the next candidate TF. Incidentally, a large enough value (infinite value) is stored as an initial value in the likelihood ratio storage unit 28.

If the likelihood ratio S is minimum in S207, the trace-back processing is executed from the position of the candidate TF (S208). That is, the trace back unit 13 references the path memory 12 to trace back survival paths and carry out hard decision to generate decoded data.

Next, the generated decoded data is subjected to CRC calculation (S209), and it is determine whether the CRC calculation result is positive or negative (S210). That is, the CRC calculation unit 25 references data area in decoded data to execute CRC calculation and compare the CRC calculation result with a value of the CRC area. If matched, the CRC decision result is OK. At this time, the decoded data undergoes the CRC calculation and is stored in the decoded data storage unit 26.

If the CRC decision result is NG in S210, the process advances to S212, and the processing is executed up to the next candidate TF. If the CRC calculation result is OK in S210, the TF output unit 27 stores the current likelihood ratio S and the current TF in the likelihood ratio storage unit 28 and the TF storage unit 29 (S211).

If the difference determination result of state S0 is negative in S206, the likelihood ratio S is not minimum in S207, the CRC decision result is NG in S210, or the likelihood ratio S and the TF are held in S211, it is subsequently determine whether or not the candidate TF position corresponds to the maximum length (S212). That is, the decoding control unit 24 compares a current candidate TF with the maximum length of the TrCH. If the candidate TF reaches the maximum length, the process advances to S214, and the decoding process is completed. If the candidate TF does not reach the maximum length in S212, the ACS calculating unit 11 obtains the next candidate TF in the descending order of size, from the candidate TF storage unit 22 to repeat the decoding process subsequent to S202 (S213).

If the difference determination of all states ends in failure in S204, or the candidate TF reaches the maximum length in S212, the TF output unit 27 outputs the minimum likelihood ratio S stored in the TF storage unit 29 as the true TF (S214). That is, the TF output unit 27 outputs a TF of the minimum likelihood ratio S for which the CRC decision result is OK before the difference determination for all states ends in failure, or outputs a TF of the minimum likelihood ratio S for which the CRC decision result is OK before decoding is completed up to the maximum length.

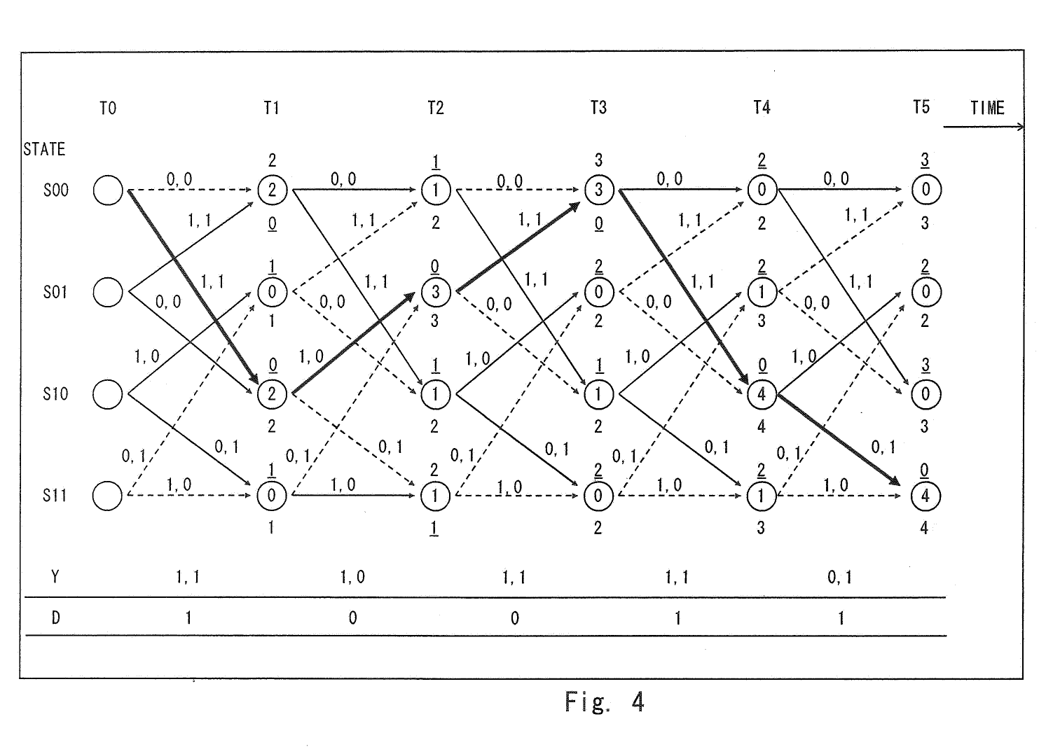

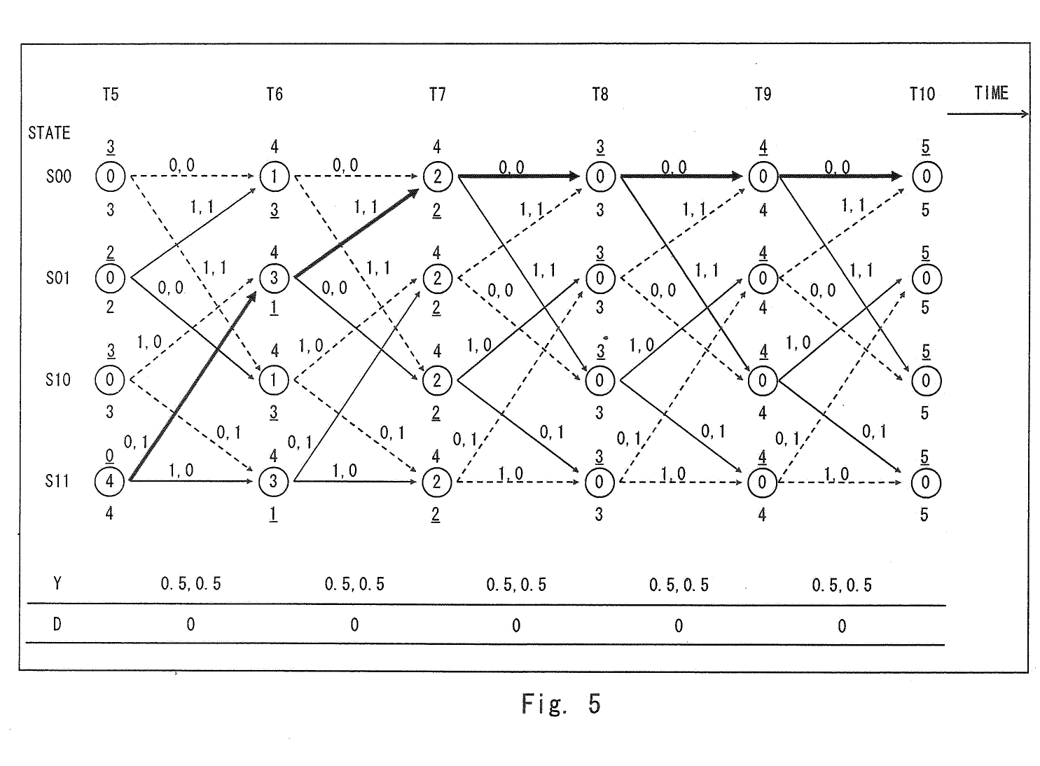

Referring next to FIGS. 4 and 5, a concrete example of the TF detecting method of this embodiment is described. In this example, the TF detecting method of FIG. 2 decodes the received data to detect the TF. FIGS. 4 and 5 show a simple example where an encoded sequence of a constraint length of 3 is decoded based on the trellis diagram with four states. In practice, however, an encoded sequence with the constraint length of 9 is decoded based on the trellis diagram with 256 states.

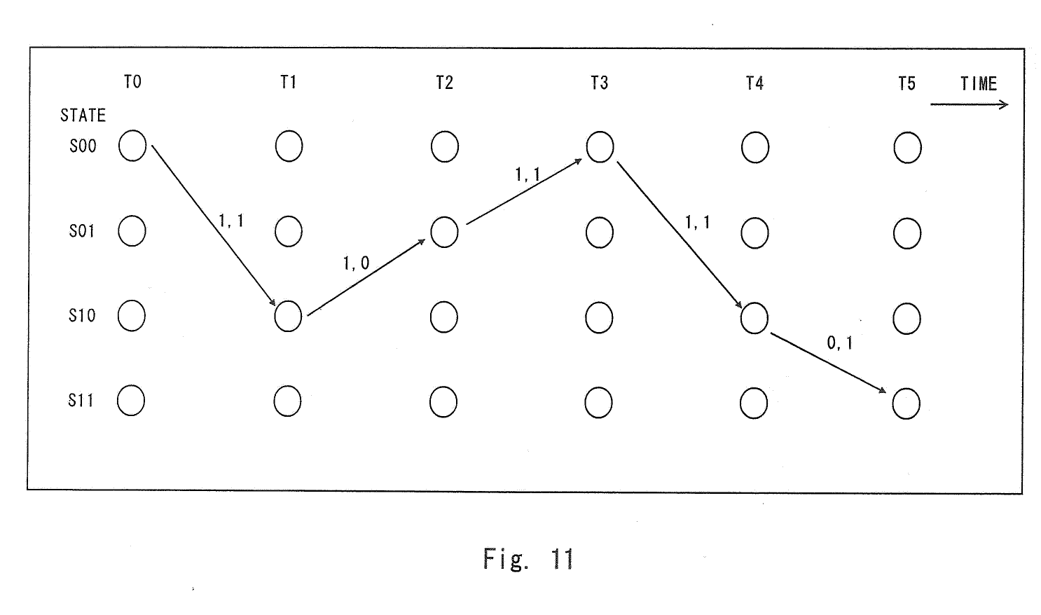

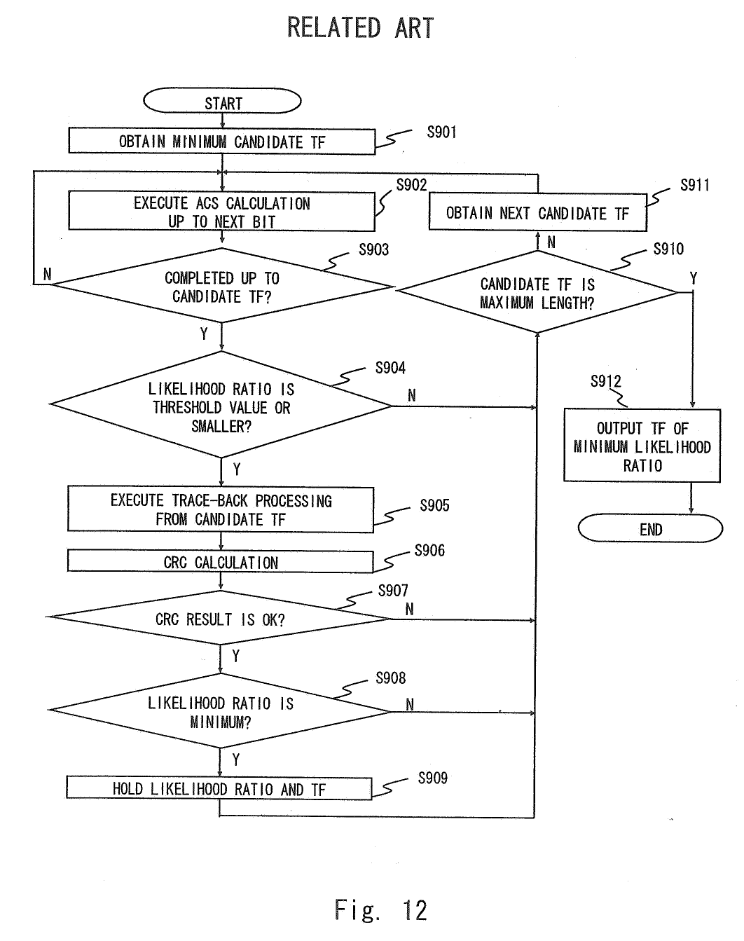

Incidentally, in this example, the convolutional-coded data of FIGS. 8 to 11 is decoded. Similar to the example of FIG. 10, in the received data, noises of an empty area follow encoded data X=“1110111101” obtained by encoding input data U=“10011”.

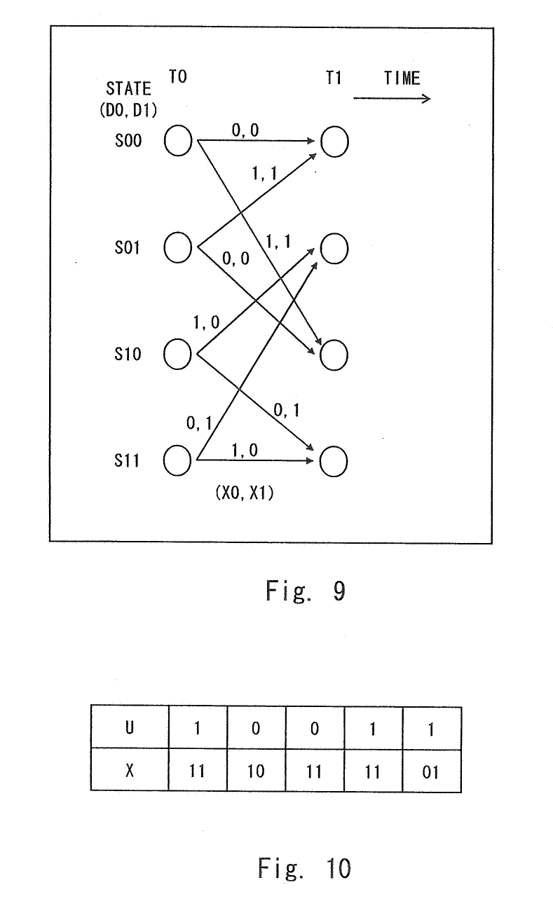

First, the trellis diagram of FIG. 4 shows how the received data is decoded from the first bit to a position before the empty area. The trellis diagram shows state transition similar to FIG. 9. In FIG. 4, branches indicated by the solid arrow among the branches connecting between states represent survival paths selected in each state, branches indicated by the thick arrow represent a survival path finally selected and traced back, and branches indicated by the dotted arrow represent paths not selected as the survival path.

In each state, a numeric value above the circle represents a pathmetric of an upper path out of the used paths, and a numeric value below the circuit represents a pathmetric of a lower path out of the used paths. The underlined one of the two pathmetrics is a pathmetric of the survival path. The circled numeric value represents a difference between the two pathmetrics.

Similar to the example of FIG. 9, a 2-bit numeric value assigned to each branch is coding bits X0, X1 expected as output bits of the coder upon the state transition. The Viterbi decoding calculates branchmetrics corresponding to the likelihood that 2 bits of the received data equal coding bits of each branch, and adds the branchmetrics of the survival path as a pathmetric.

Various methods can be used for calculating branchmetrics. In this example, the branchmetric is set as a hamming distance between two bit sequences. The hamming distance corresponds to the number of bits between two bit sequences. For example, as for “00” and “11”, there is a difference of 2 bits, so the hamming distance is 2.

In the case of selecting pathmetrics, a path of a smaller pathmetric is selected from the paths up to each state as a path of higher likelihood and used as the survival path here. If the pathmetrics are equal, any path can be selected. In this example, an upper path is selected.

First, when received data (Y) is input, ACS calculation (S202) and differential calculation (S203) are carried out by 2 bits at each point of the trellis diagram. At time T1, in each of states S00 to S11, “11” of the received data (Y) is compared with the coding bit of each branch to calculate branchmetrics and calculate pathmetrics.

For example, in state S00 at time T1, a branchmetric of an upper branch is 2, and a branchmetric of a lower branch is 0. Here, there is not path up to time T0, so branch=path, and the branchmetric becomes the pathmetric at time T1. Thus, a pathmetric of the lower path is smaller than that of an upper path, so the lower path is selected as the survival path. Further, the pathmetric of the lower path is subtracted from the pathmetric of the upper path, and a difference between the likelihood information becomes 2.

At the next time T2 as well, “10” of the received data (Y) is similarly compared with the coding bit of each branch in each state to thereby calculate a difference between the pathmetric and the pathmetric. For example, in state S11 at time T2, a branchmetric of an upper branch is 2, and a branchmetric of a lower branch is 0. When the above is added to the pathmetric at time T1, the pathmetric of the upper path becomes 2, and the pathmetric of the lower path becomes 1 to select the lower path as a survival path. Further, the pathmetric of the lower path is subtracted from the pathmetric of the upper path, and a difference between the likelihood information becomes 1.

The above process is repeated up to time T5, and an upper path of state S00, an upper path of state S01, an upper path of state S10, and an upper path of state S11 are defined as a survival path. A pathmetric of the survival path (thick-line path) in state S11 becomes 0, that is, minimized.

Assuming that the trace back processing is executed from this point, the pathmetrics are traced back through the minimum path in all states. In FIG. 4, the thick-line paths are traced back in the order from state S11 of time T5-state S10 of time T4-state S00 of time T3-state S01 of time T2-state S10 of time T1-state S00 of time T0. At this time, if each state is shifted to an upper side or state S00, the decoding bit is set to 0. If each state is shifted to the lower side or state S11, the decoding bit is set to 1. In this way, in the trace-back processing, the decoding bit becomes 1 at T5-T4, the decoding bit becomes 1 at T4-T3, the decoding bit becomes 0 at T3-T2, the decoding bit becomes 0 at T2-T1, and the decoding bit becomes 1 at T1-T0. A bit sequence of “11001” is obtained. If decoded in the reverse order, this bit sequence is “10011”, and correct decoded data (D) can be obtained.

The trellis diagram of FIG. 5 shows how an empty area is decoded following the decoding process of FIG. 4. The empty data is noise data, not 0 or 1. In this example, the empty data is 0.5 an intermediate value between 0 and 1.

In this example as well, similar to the example of FIG. 4, the ACS calculation (S202) and the difference calculation (S203) are carried out. That is, at time T6, in each state, “0.5, 0.5” of the received data (Y) is compared with the coding bit of each branch to calculate a difference between the pathmetric and the pathmetric. For example, in state S01 at time T6, the branchmetric of the upper branch becomes 1, and the branchmetric of the lower branch becomes 1. If the above is added to the pathmetric at time T5, the pathmetric of the upper path becomes 4, and the pathmetric of the lower path becomes 1 to select the lower path as a survival path. Further, the pathmetric of the lower path is subtracted from the pathmetric of the upper path, and a difference between the likelihood information becomes 3.

Then, the above is repeated from time T5 to time T10, so the pathmetrics of all states become equal to 5, and it is difficult to determine which state attains the maximum likelihood. Incidentally, if paths are traced back from time T10, the branches are shifted to the same state, so the decoded data (D) becomes “00000”.

As shown in FIGS. 4 and 5, in the case of decoding data of 0 or 1 from time T0 to time T5, a difference between a pathmetric of a path with a high likelihood and a pathmetric of a wrong path tends to increase. Further, in the case of decoding an empty data from time T5 to time T10, a difference between the pathmetrics tends to decrease. For example, a difference between pathmetrics is 6 in state S11 at time T5, and a difference between pathmetrics of all states at time T10 becomes 0.

Hence, if the pathmetrics are calculated in the order from the first bit, when a pathmetric difference is large, a reliability of the decoding result is high, and there is high possibility that a target area is a data area or a CRC area. If the pathmetric difference is small, a reliability of the decoding result is low, and there is a high possibility that a target area is an empty area. Thus, if a difference between pathmetrics of all states is small in this embodiment, it is determined that the decoding process is completed up to the empty area, and the decoding process is completed halfway.

For example, in FIGS. 4 and 5, if a threshold value for determining a pathmetric difference is 0, a difference between pathmetrics of all states at time T8 is 0, the result of determining a difference between pathmetrics of all states is NG, and the decoding process is completed. Then, for example, TF at time T5 before time T8 is output as the true TF.

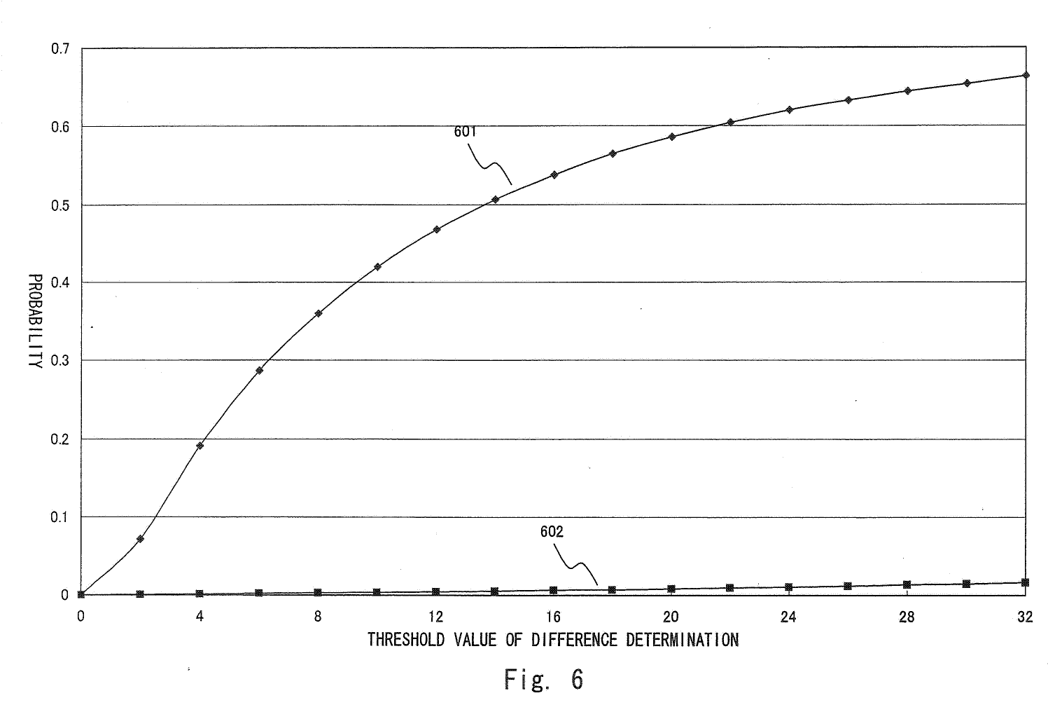

FIG. 6 shows a simulation result example of the TF detecting method of this embodiment. In FIG. 6, the horizontal axis represents a threshold value for difference determination, and the curve 601 represents the probability that the decoding process is completed at a position less than the maximum length. As shown in FIG. 6, as the threshold value increases, the probability that the decoding process is completed halfway becomes high. In the example of FIG. 6, if the threshold value is 15, the decoding process is completed halfway with about 50% probability. Incidentally, FIG. 6 shows a simulation result example where the input data is soft input data (−1 to +1), unlike the examples of FIGS. 4 and 5. The curve is largely changed in accordance with the simulation conditions such as noises or a data length of a selected TF (candidate TF), and the threshold value or probability is also changed.

If the threshold value increases, the probability that the decoding process is completed halfway becomes high, but the probability that the decoding process is erroneously stopped becomes high. In contrast, if the threshold value decreases, the probability that the decoding process is completed halfway is lowered, but the probability that the decoding process is erroneously stopped is lowered.

For example, the threshold value is preferably suitable for conditions of the communication path (probability of occurrence of noises). If a quality of the communication path is high, the threshold value is set large so that the decoding process is easily completed halfway. If a quality of the communication path is not high, the threshold value is set small so that the decoding process is hardly completed halfway.

As described above, in this embodiment, at the time of decoding the received data, a difference between likelihood information is calculated, and the decoding process is completed based on the difference to detect a TF. As a result, the decoding process can be completed at a position less than the maximum length, so it is possible to avoid such a situation that the data is decoded up to the maximum length in vain and to considerably reduce a decoding amount. Thus, a period necessary for detecting a TF can be reduced, and a circuit size or calculation amount of the TF detecting apparatus can be reduced to save power consumption.

### Other Embodiment

Incidentally, in the flowchart of FIG. 2, if there is not yet a TF for which the CRC calculation result is OK, the result of determining a difference between pathmetrics of all states is NG, and the determination may be completed. In the simulation result example of FIG. 6, the curve 602 represents the probability that the decoding process is erroneously completed. In the example of FIG. 6, if the threshold value is 14, the decoding process is erroneously completed with the probability of about 0.5%. Thus, even if the difference determination for all states ends in failure, it is preferred to continue the decoding process unless at least one TF for which the CRC decision result is OK is detected.

Further, in the above example, as a reference for detecting an empty area and stopping a decoding processing halfway, a difference between likelihood information is used. However, the present invention is not limited thereto, and an empty area may be detected to complete decoding, based on the other information.

It is apparent that the present invention is not limited to the above embodiment that may be modified and changed without departing from the scope and spirit of the invention.

What is claimed is:

1. A transport format detecting apparatus, comprising:
a decoding unit calculating likelihood information of a plurality of paths up to each state of a trellis diagram based on a received sequence to generate a decoded sequence;
a differential operational unit calculating a difference between the likelihood information in each state;
a decoding control unit stopping generation of decoded sequence with the decoding unit based on the difference between the likelihood information; and
a detecting unit detecting a transport format based on a size of the generated decoded sequence.

2. The transport format detecting apparatus according to claim 1, wherein the decoding control unit stops generation of the decoded sequence based on a difference between likelihood information of all states at a predetermined time point.

3. The transport format detecting apparatus according to claim 1, wherein the decoding control unit stops generation of the decoded sequence if the difference between the likelihood information is smaller than a predetermined threshold value.

4. The transport format detecting apparatus according to claim 2, wherein the decoding control unit stops generation of the decoded sequence if the difference between the likelihood information is smaller than a predetermined threshold value.

5. The transport format detecting apparatus according to claim 1, wherein the difference between the likelihood information corresponds to a difference between pathmetrics of the plurality of paths up to each state.

6. The transport format detecting apparatus according to claim 2, wherein the difference between the likelihood information corresponds to a difference between pathmetrics of the plurality of paths up to each state.

7. The transport format detecting apparatus according to claim 3, wherein the difference between the likelihood information corresponds to a difference between pathmetrics of the plurality of paths up to each state.

8. The transport format detecting apparatus according to claim 4, wherein the difference between the likelihood information corresponds to a difference between pathmetrics of the plurality of paths up to each state.

9. The transport format detecting apparatus according to claim 1, wherein the decoding unit includes:
an add-compare-select unit calculating likelihood information of the plurality of paths up to each state and selecting a survival path from among the plurality of paths; and
a trace-back unit tracing back the selected survival path to generate decoded sequence, and
the decoding control unit calculates a difference between the likelihood information after calculating the likelihood information, and stops processings of the add-compare-select unit and the trace-back unit.

10. The transport format detecting apparatus according to claim 2, wherein the decoding unit includes:
an add-compare-select unit calculating likelihood information of the plurality of paths up to each state and selecting a survival path from among the plurality of paths; and
a trace-back unit tracing back the selected survival path to generate decoded sequence, and
the decoding control unit calculates a difference between the likelihood information after calculating the likelihood information, and stops processings of the add-compare-select unit and the trace-back unit.

11. The transport format detecting apparatus according to claim 3, wherein the decoding unit includes:
an add-compare-select unit calculating likelihood information of the plurality of paths up to each state and selecting a survival path from among the plurality of paths; and
a trace-back unit tracing back the selected survival path to generate decoded sequence, and
the decoding control unit calculates a difference between the likelihood information after calculating the likelihood information, and stops processings of the add-compare-select unit and the trace-back unit.

12. The transport format detecting apparatus according to claim 4, wherein the decoding unit includes:
an add-compare-select unit calculating likelihood information of the plurality of paths up to each state and selecting a survival path from among the plurality of paths; and
a trace-back unit tracing back the selected survival path to generate decoded sequence, and
the decoding control unit calculates a difference between the likelihood information after calculating the likelihood information, and stops processings of the add-compare-select unit and the trace-back unit.

13. The transport format detecting apparatus according to claim 1, wherein the decoding unit executes decoding up to a plurality of candidate sizes of a transport format, and
the detecting unit outputs the candidate size less than a position where generation of the decoded sequence is stopped, as the transport format.

14. The transport format detecting apparatus according to claim 2, wherein the decoding unit executes decoding up to a plurality of candidate sizes of a transport format, and
the detecting unit outputs the candidate size less than a position where generation of the decoded sequence is stopped, as the transport format.

15. The transport format detecting apparatus according to claim 3, wherein the decoding unit executes decoding up to a plurality of candidate sizes of a transport format, and
the detecting unit outputs the candidate size less than a position where generation of the decoded sequence is stopped, as the transport format.

16. The transport format detecting apparatus according to claim 4, wherein the decoding unit executes decoding up to a plurality of candidate sizes of a transport format, and
the detecting unit outputs the candidate size less than a position where generation of the decoded sequence is stopped, as the transport format.

17. The transport format detecting apparatus according to claim 1, wherein the detecting unit detects a transport format based on a result of executing cyclic redundancy check on the generated decoded sequence.

18. The transport format detecting apparatus according to claim 2, wherein the detecting unit detects a transport format based on a result of executing cyclic redundancy check on the generated decoded sequence.

19. The transport format detecting apparatus according to claim 3, wherein the detecting unit detects a transport format based on a result of executing cyclic redundancy check on the generated decoded sequence.

20. A transport format detecting method, comprising:
calculating likelihood information of a plurality of paths up to each state of a trellis diagram based on a received sequence to generate a decoded sequence;
calculating a difference between the likelihood information in each state;
stopping generation of decoded sequence with the decoding unit based on the difference between the likelihood information; and
detecting a transport format based on a size of the generated decoded sequence.
